(19) United States
(12) Patent Application Publication
(10) Pub. No.: US 2017/0001270 A1
(43) Pub. Date: Jan. 5, 2017

(54) PIPE CRIMPING TOOL

(71) Applicant: SUN-WONDER INDUSTRIAL CO., LTD., Taoyuan City (TW)

(72) Inventor: Chia-Chun CHANG, Taoyuan City (TW)

(21) Appl. No.: 14/821,770

(22) Filed: Aug. 9, 2015

(30) Foreign Application Priority Data
Jun. 30, 2015 (TW) 104210498

(51) Int. Cl. B23P 11/00; B25B 27/14

(52) U.S. Cl. CPC B23P 11/005; B25B 27/14

(57) ABSTRACT

A pipe crimping tool includes a positioning unit including a positioning base defining therein a positioning space and having a connection portion and a first side arm amd a second side arm respectively extended from two opposite ends of the connection portion in parallel and respectively terminating in a first stopper and a second stopper, two position-limit members respectively disposed at the first side arm and the second side arm at a bottom side, a connection unit pivotally connected to the first stopper and lockable to the second stopper to close the passage of the positioning space, and a hydraulic cylinder connected to the positioning base to hold a pressure block in the positioning space and operable to move the pressure block in achieving a crimping operation.

### BACKGROUND OF THE INVENTION

1. Field of the Invention:

The present invention relates to processing blocks, and more particularly to a pipe crimping tool, which is applicable for processing pipes of different shapes.

2. Description of the Related Art:

When connecting two pipes in a line, the conventional method is to expand one end of each pipe, and then to attach each pipe to a respective one end of a pipe connector, and then to crimp each pipe onto the pipe connector using a pipe crimping tool. However, pipes may need to be bent into different shapes for different applications. A specially curved pipe cannot be inserted into a conventional pipe crimping tool and then crimped onto a pipe connector, and thus, the pipe crimping tool becomes unworkable in this situation.

### SUMMARY OF THE INVENTION

The present invention has been accomplished under the circumstances in view. It is therefore the main object of the present invention to provide a pipe crimping tool, which has a passage defined in a positioning unit thereof and closable by a connection unit so that a pipe and a pipe connector of any shape can be conveniently positioned in the positioning unit and crimped by a hydraulic device.

To achieve this and other objects of the present invention, a pipe crimping tool in accordance with the present invention comprises a positioning unit, a connection unit and a hydraulic device. The positioning unit comprises a positioning base that comprises a connection portion, a first side arm and a second side arm respectively extended from two opposite ends of the connection portion in one same direction and a positioning space defined between the first side arm and the second side arm, a first stopper located at a distal end of the first side arm, a second stopper located at a distal end of the second side arm, and a passage defined between the first stopper and the second stopper in communication with the positioning space. The connection unit comprises a connection base that comprises a base portion, a pivot connection portion located at one side of the base portion and a positioning portion located at an opposite side of the base portion, a pivot pin pivotally connecting the pivot connection portion to the first stopper, and a plug rod adapted for locking the positioning portion to the second stopper. The hydraulic device comprises a hydraulic cylinder, an operating handle operable to drive the hydraulic cylinder and a pressure block movable by the hydraulic cylinder. The hydraulic cylinder has one end thereof connected to the connection portion of the positioning base to hold the pressure block in between the first side arm and second side arm of the positioning base in such a manner that the pressure block is movable by the hydraulic cylinder toward the connection base subject to the control of the operating handle.

### BRIEF DESCRIPTION OF THE DRAWINGS

FIG. 1 is an oblique top elevational view of a pipe crimping tool in accordance with the present invention.

FIG. 2 is a right side view of the pipe crimping tool in accordance with the present invention.

FIG. 3 is a left side view of the pipe crimping tool in accordance with the present invention.

FIG. 4 is a bottom view of the pipe crimping tool in accordance with the present invention.

FIG. 5 is a plain view of the position-limit member according to the present invention.

FIG. 6 is a schematic drawing illustrating an adjustment operation of the position-limit mechanism according to the present invention.

FIG. 7 is an exploded view illustrating the relationship between first and second pipes and a pipe connector.

FIG. 8 is a schematic applied view of the present invention, illustrating a first pipe inserted into the positioning unit before locking of the connection unit.

FIG. 9 corresponds to FIG. 8, illustrating the connection unit locked to the positioning unit.

FIG. 10 is a schematic top view illustrating the hydraulic device operated and the crimping blocks crimped onto the first pipe.

FIG. 11 corresponds to FIG. 7, illustrating the first pipe and the second pipe crimped and affixed to the pipe connector.

### DETAILED DESCRIPTION OF THE PREFERRED EMBODIMENT

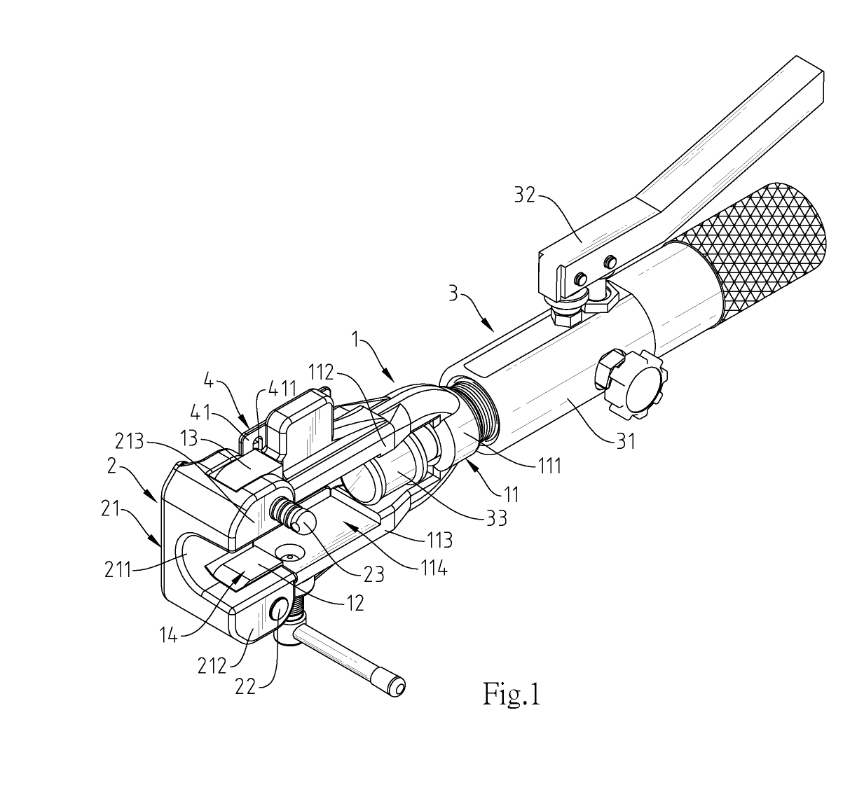

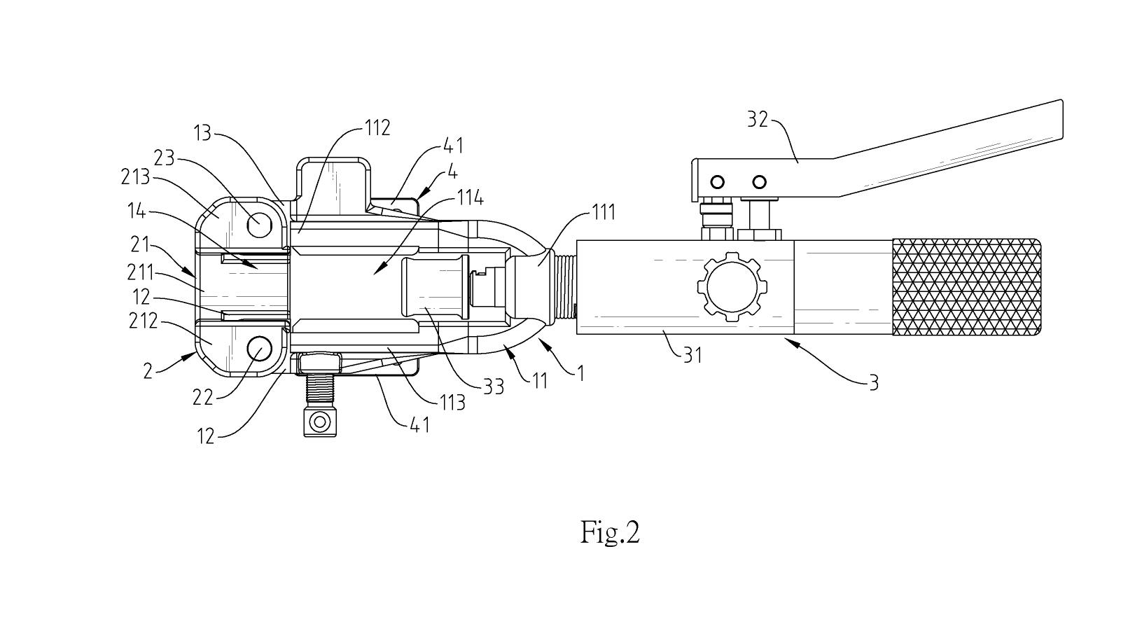

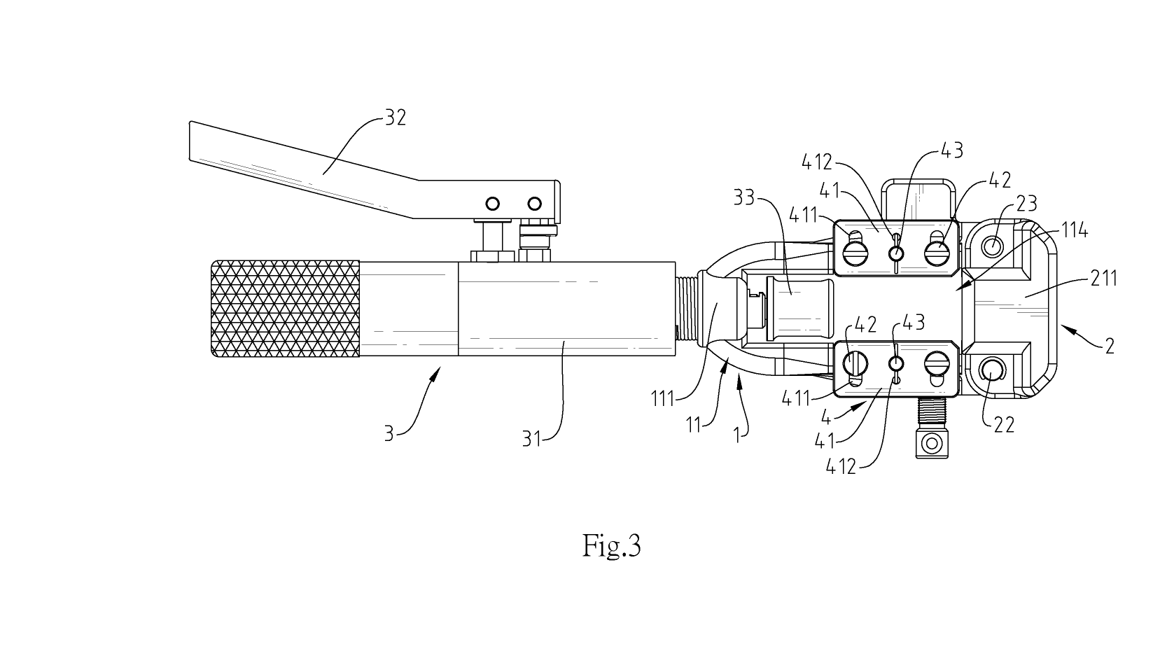

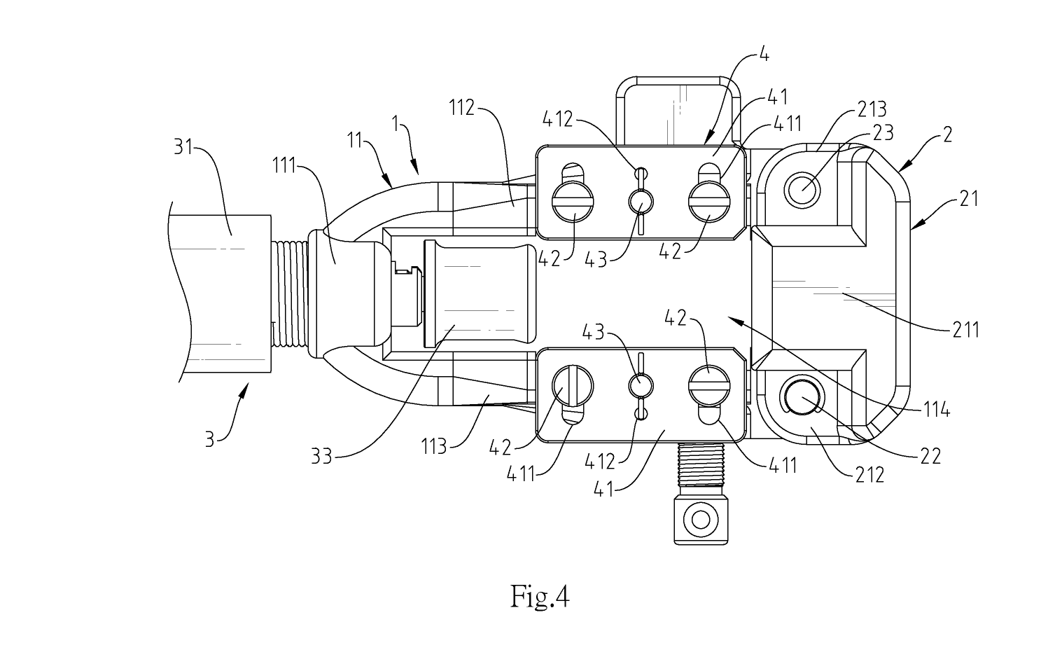

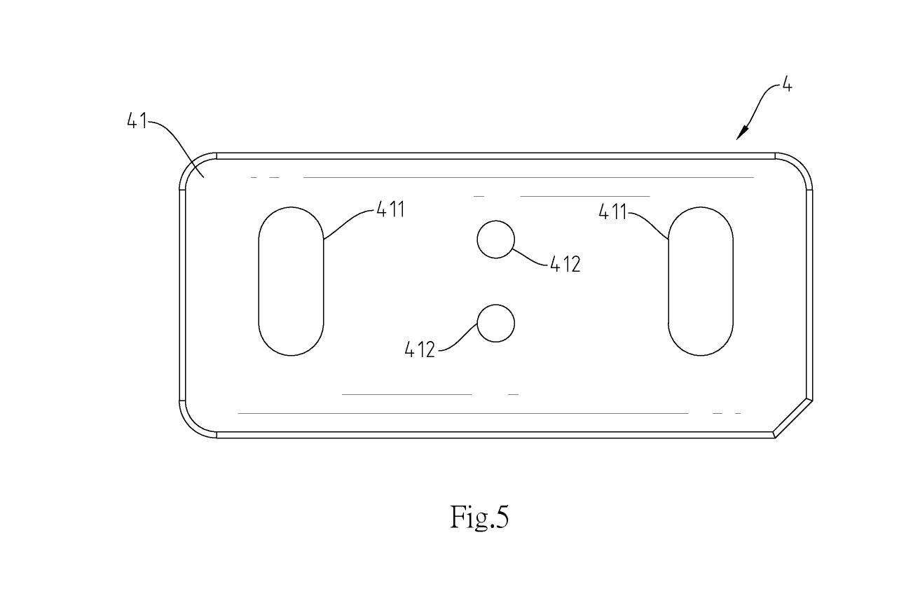

Referring to FIGS. 1-5, a pipe crimping tool in accordance with the present invention is shown. The pipe crimping tool comprises a positioning unit 1, a connection unit 2, hydraulic device 3, and a position-limit mechanism 4.

The positioning unit 1 comprises a positioning base 11, which comprises a connection portion 111, a first side arm 112 and a second side arm 113 connection portion 111 respectively extended from two opposite ends of the connection portion 111 in one same direction and a positioning space 114 defined between the first side arm 112 and the second side arm 113, a first stopper 12 located at a distal end of the first side arm 112, a second stopper 13 located at a distal end of the second side arm 113 and defining therein a positioning hole 131, and a passage 14 defined between the first stopper 12 and the second stopper 13 in communication with the positioning space 114.

The connection unit 2 comprises a connection base 21 comprising a base portion 211, a pivot connection portion 212 located at one side of the base portion 211, a positioning portion 213 located at an opposite side of the base portion 211 and a plug hole 214 located in the positioning portion 213, a pivot pin 22 pivotally connecting the pivot connection portion 212 to the first stopper 12, and a plug rod 23 pluggable into the positioning hole 131 of the second stopper 13 and the plug hole 214 to fasten the positioning portion 213 to the second stopper 13.

The hydraulic device 3 comprises a hydraulic cylinder 31, a operating handle 32 pivotally connected to the hydraulic cylinder 31, and a pressure block 33 connected to one end, namely, the movable end of the hydraulic cylinder 31. The hydraulic cylinder 31 is connected to the connection portion 111 of the positioning base 11 of the positioning unit 1 to hold the pressure block 33 in between the first side arm 112 and the second side arm 113, enabling the pressure block 33 to be moved toward the connection base 21 by the hydraulic cylinder 31 subject to the control of the operating handle 32.

The position-limit mechanism 4 is mounted at a bottom side of the positioning base 11 of the positioning unit 1, comprising two position-limit members 41 respectively disposed at the first side arm 112 and second side arm 113 of the positioning base 11 at a bottom side, an elongated position-limit slot 411 located in each position-limit member 41, a positioning hole 412 located in each position-limit member 41 at one side relative to the elongated position-limit slot 411, a positioning member 42 mounted in each elongated position-limit slot 411 and connected with a bottom end thereof to the first side arm 112 or second side arm 113 for enabling the two position-limit members 41 to be moved along the respective elongated position-limit slots 411 in direction toward or away from each other, and a plurality of fastening members 43 respectively inserted through the positioning holes 412 in the position-limit members 41 and respectively fastened to the first side arm 112 and the second side arm 113 to lock the position-limit members 41 to the first side arm 112 and second side arm 113 of the positioning base 11.

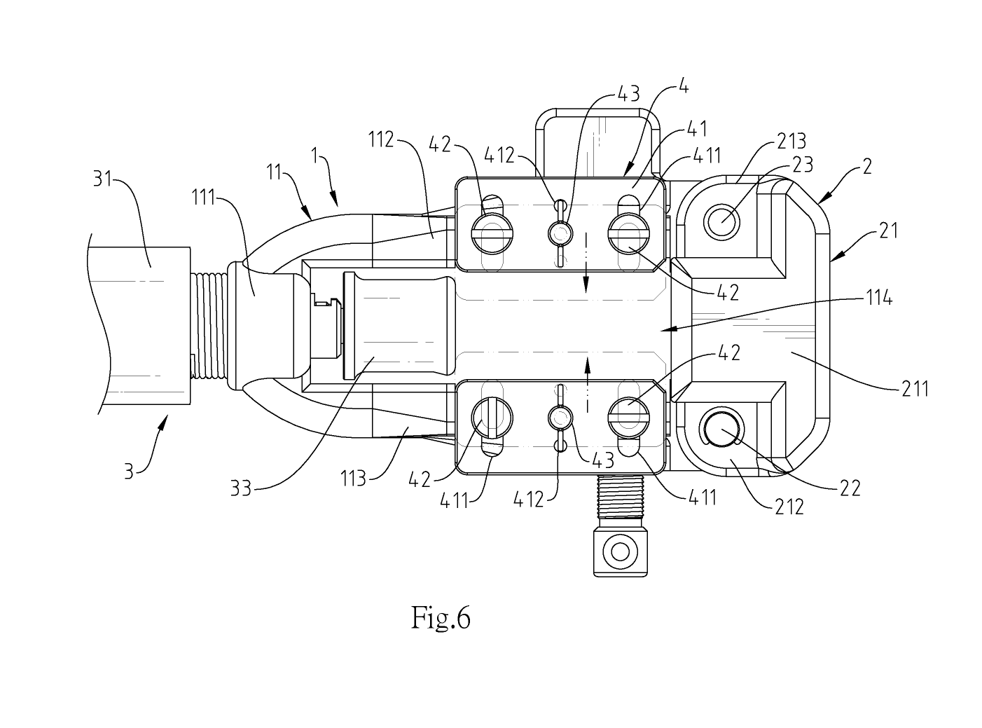

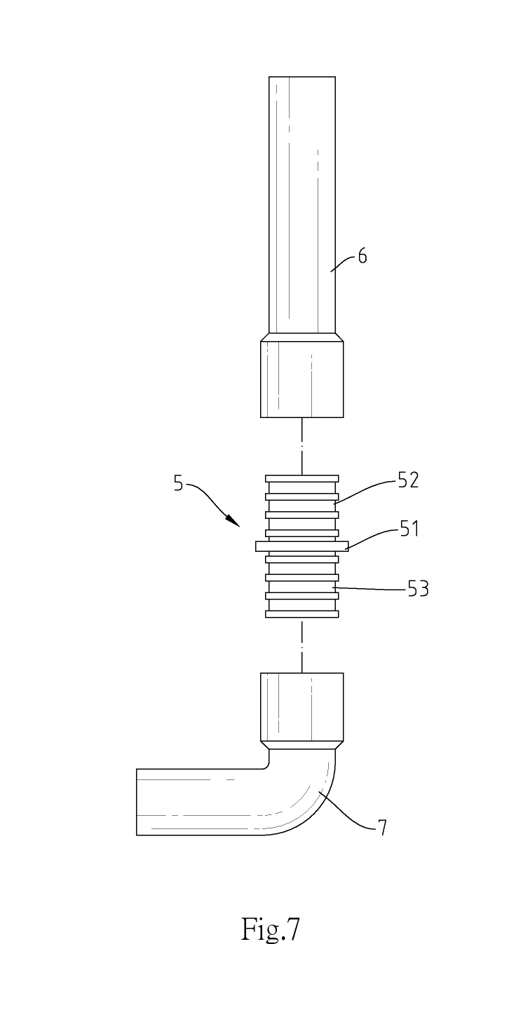

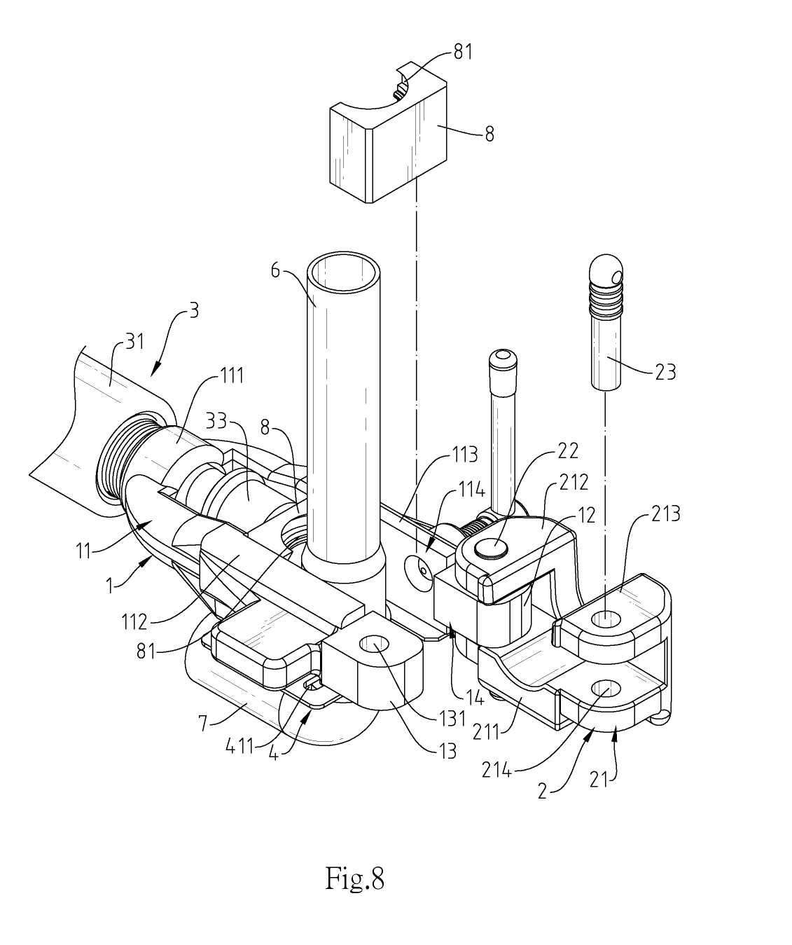

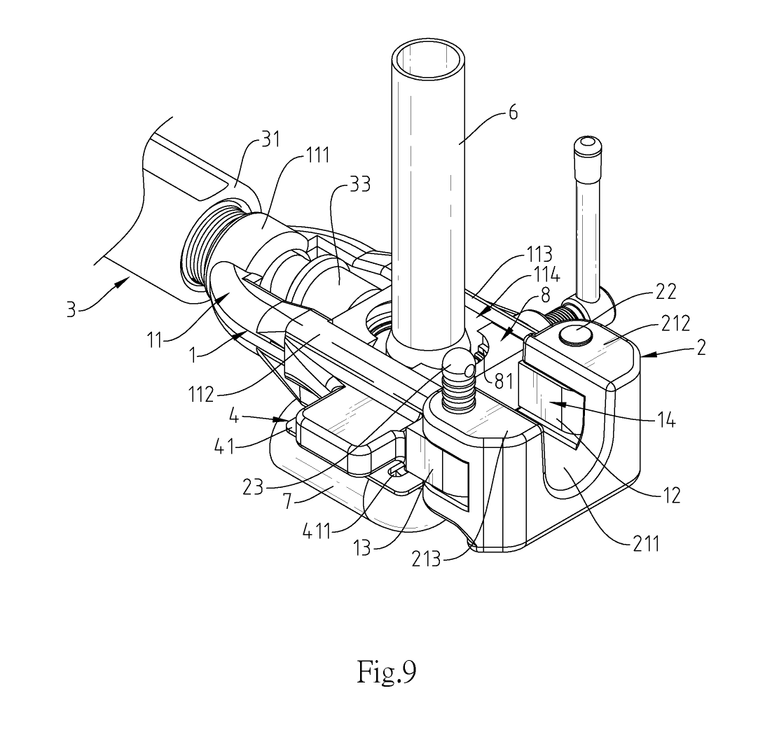

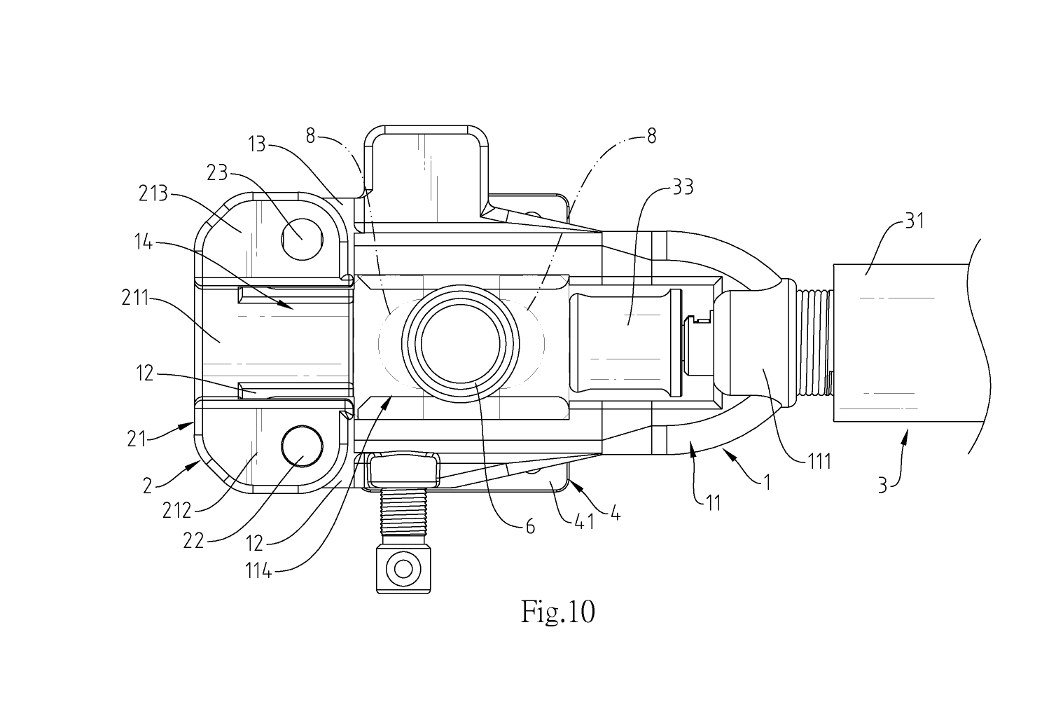

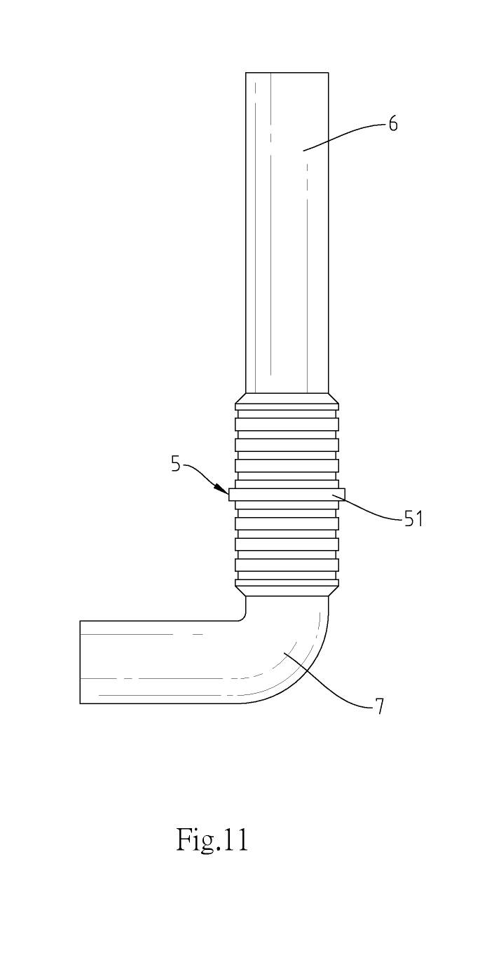

Referring to FIG. 1 and FIGS. 4-11, during the crimping operation, the positioning members 42 can be moved along the respective elongated position-limit slots 411 in direction toward or away from each other to adjust the gap between the two position-limit members 41, and then the fastening members 43 are inserted through the respective positioning holes 412 to lock the position-limit members 41 to the first side arm 112 and the second side arm 113 respectively. After adjustment of the distance between the positioning holes 412 in the two position-limit members 41, insert a pipe connector 5 into the positioning space 114 to let a collar 51 of the pipe connector 5 be supported on the two position-limit members 41 and to keep a second connection end 53 of the pipe connector 5 in the positioning space 114, and then attach one end of a second pipe 7 onto the second connection end 53 of the pipe connector 5 to let the second pipe 7 be squeezed between two crimping blocks 8 that are positioned in the positioning space 114 of the positioning base 11 and respectively abutted against the position-limit members 41, thereafter, operate the operating handle 32 to drive the hydraulic cylinder 31 in moving the pressure block 33 toward the connection unit 2. At this time, the pressure block 33 is forced to move the crimping blocks 8 toward each other, causing internal crimping threads 81 of the crimping blocks 8 to crimp the second pipe 7 onto the second connection end 53, and thus, the second pipe 7 and the second connection end 53 of the pipe connector 5 are crimped together. However, when going to affix the first pipe 6 to the first connection end 52 of the pipe connector 5 after fixation of the second pipe 7 to the second connection end 53, the pipe connector 5 cannot be positioned in the positioning space 114 from the top side, at this time, the user needs to remove the plug rod 23 from the positioning hole 131 and the plug hole 214 and then turn the connection unit 2 about the axis of the pivot pin 2 relative to the first stopper 12 to open the passage 14, and then hold the pipe connector 5 in vertical and insert it horizontally into the passage 14 to let the collar 51 of the pipe connector 5 be supported on the two position-limit members 41 and to keep the first connection end 52 of the pipe connector 5 in the positioning space 114, and then fasten the plug rod 23 to the positioning hole 131 and the plug hole 214 to lock thee pivot pin 2 relative to the positioning unit 1, and then attach the first pipe 6 onto the first connection end 52 to let the first pipe 6 be squeezed between the two crimping blocks 8, and then, operate the operating handle 32 to drive the hydraulic cylinder 31 in moving the pressure block 33 toward the connection unit 2, and thus, the pressure block 33 is forced to move the crimping blocks 8 toward each other, crimping the first pipe 6 onto the first connection end 52, and thus, the first pipe 6 and the first connection end 52 of the pipe connector 5 are crimped together.

After crimping, remove the plug rod 23 from the positioning hole 131 and the plug hole 214 and then open the connection unit 2 from the positioning unit 1 for allowing removal of the pipe connector 5 horizontally out of the passage 14, and thus, the complete crimping operation is done.

What the invention claimed is:

1. A pipe crimping tool, comprising:
a positioning unit comprising a positioning base, said positioning base comprising a connection portion, a first side arm and a second side arm respectively extended from two opposite ends of said connection portion in one same direction and a positioning space defined between said first side arm and said second side arm, a first stopper located at a distal end of said first side arm, a second stopper located at a distal end of said second side arm, and a passage defined between said first stopper and said second stopper in communication with said positioning space;
a connection unit comprising a connection base, said connection base comprising a base portion, a pivot connection portion located at one side of said base portion and a positioning portion located at an opposite side of said base portion, a pivot pin pivotally connecting said pivot connection portion to said first stopper, and a plug rod adapted for locking said positioning portion to said second stopper; and
a hydraulic device comprising a hydraulic cylinder, an operating handle operable to drive said hydraulic cylinder and a pressure block movable by said hydraulic cylinder, said hydraulic cylinder having one end thereof connected to said connection portion of said positioning base to hold said pressure block in between said first side arm and said second side arm of said positioning base in such a manner that said pressure block is movable by said hydraulic cylinder toward said connection base subject to the control of said operating handle.

2. The pipe crimping tool as claimed in claim 1, wherein said second stopper of said positioning unit comprises a positioning hole; said positioning portion of said connection unit comprises a plug hole; said plug rod is adapted for plugging into said positioning hole and said plug hole to lock said positioning portion to said second stopper.

3. The pipe crimping tool as claimed in claim 1, further comprising a position-limit mechanism located at a bottom side of said positioning base of said said positioning unit, said position-limit mechanism comprising two position-limit members respectively located at said first side arm and said second side arm of said positioning base at a bottom side, each said position-limit member comprising an elongated position-limit slot, and two positioning members respectively mounted in the two said elongated position-limit slots and respectively connected to said first side arm and said second side arm and movable along the respectively said position-limit slots in two reversed directions toward or away from each other.

4. The pipe crimping tool as claimed in claim 3, wherein each said position-limit member comprises a positioning hole disposed at one side relative to the respective said elongated position-limit slot; said two fastening members are respectively inserted through said positioning holes in said position-limit members and respectively unfastenably fastened to said first side arm and said second side arm to lock said position-limit members to said first side arm and said second side arm of said positioning base.
